(19) United States
(12) Patent Application Publication
(10) Pub. No.: US 2019/0159434 A1
(43) Pub. Date: May 30, 2019

(54) Device for Rearing Aquaculture Animals At Sea

(71) Applicant: GENOCEAN, Saint-Martin-de-Re (FR)

(72) Inventors: Eric MARISSAL, Saint-Martin-de-Ré (FR); Lila PINCOT, La Flotte (FR)

(21) Appl. No.: 16/316,032

(22) PCT Filed: Jul. 26, 2017
(86) PCT No.: PCT/EP2017/068885

§ 371 Date: Jan. 7, 2019

(30) Foreign Application Priority Data
Jul. 29, 2016 (FR) 16 57372

(51) Int. Cl. A01K 61/55; A01K 61/65

(52) U.S. Cl. CPC A01K 61/55; A01K 61/65

(57) ABSTRACT

The device for rearing aquaculture animals at sea including at least one stack of rearing enclosures superimposed on top of each other in a longitudinal direction, and blades linked to the rearing enclosures and arranged such that the rearing enclosures are rotated around a longitudinal axis by the sea current; the rotation combined with the inclination of the longitudinal axis produced by the current causes the animals to roll against each other in the enclosures during periods of strong current.

### CROSS-REFERENCE TO RELATED APPLICATIONS

This application claims benefit under 35 USC § 371 of PCT Application No. PCT/EP2017/068885 entitled DEVICE FOR REARING AQUACULTURE ANIMAL AT SEA, filed on Jul. 26, 2017 by inventors Eric Marissal and Lila Pincot. PCT Application No. PCT/EP2017/068885 claims priority of French Patent Application No. 16 57372, filed on Jul. 29, 2016.

### FIELD OF THE INVENTION

The invention generally relates to devices for rearing aquaculture animals at sea, in particular shellfish and more particularly oysters.

### BACKGROUND OF THE INVENTION

In all oyster farming countries, the oysters are reared on substrates or in containers fixed in the intertidal zone, and are subject to climate, biological or chemical hazards that may damage the rearing performance.

Approximately thirty years ago, the longline offshore farming technique appeared. On such farms, the oysters are constantly submerged offshore and benefit from stable and healthy environmental conditions. They experience exceptional growth. They are for example farmed from in flexible Japanese lanterns, of the type described in patent application EP 0,682,863.

Another offshore farming technique developed about fifteen years ago consists of farming the oysters in containers stored in steel cages.

Still another offshore farming technique consists of using rigid baskets, stacked on one another, thus forming a rigid lantern.

These last two techniques have three major drawbacks.

The first drawback is the bulk, since the volume of the containers/baskets is incompressible during transport, and represents ten times the volume of the farmed oysters.

The second problem is the dirtying of the grates making up the containers/baskets. The meshes must be cleaned very regularly, and even more often when the mesh is small. Small meshes are used to farm very small shellfish.

The third drawback is the weight of the containers/baskets. These must be very rigid, since they are used under demanding environmental conditions.

The flexible Japanese lanterns on the contrary have many advantages. They have a small bulk when they are not in use. The nets are disposable, such that it is not necessary to clean them, even when a net with a small mesh is used for juvenile farming.

Conversely, they procure an exceptionally high growth speed, in particular for young oysters, such that the lanterns fill up very quickly and the oysters located on a same tray clump quickly. This leads to the need to intervene very frequently in order to split and separate the oysters, which is difficult to reconcile with mass production.

A farming device according to the state of the art, using Japanese lanterns, is shown in FIG. 1. This device includes a cable 2, also called hawser, the ends 4 and 6 of which are moored on the bottom 8 of the sea using ballasts 10, 12 connected by cables 14 and 16 to the ends 4 and 6, respectively. The cables 14 and 16 for example have a length of about 30 meters. The hawser 2 has a length of about 100 m.

At regular intervals of about 6 m, as well as at both ends 4 and 6, buoys 18 are arranged connected to the hawser 2 via ropes 20. This makes it possible to keep the hawser at a depth of about 1 m and approximately parallel to the sea bottom 8.

Japanese lanterns 22 are hung below the hawser while being regularly spaced apart along the latter.

Each Japanese lantern 22 is made up of a set of superimposed trays 28 connected to one another by ropes. The oysters 29 are arranged on said trays. The net 24 in tube form marries the edge of the trays so as to prevent the oysters from going from one level to another. The assembly forms a Japanese lantern 22 extending approximately vertically in the absence of any substantial current, each lantern being connected in its lower part to a ballast 26.

The effectiveness of the Japanese lanterns for the growth of the oysters is based on the use of the ballast 26. This allows the lantern to remain vertical despite the sea currents, such that the seawater forcibly passes through the net and provides an excellent supply for the oysters located inside the Japanese lantern.

Conversely, as indicated above, excess growth is observed for oysters farmed under these conditions characterized by great shell fragility, as well as dirtying of the interstitial environments between the animals, on the trays, which may lead to over-mortality if the upkeep and splitting operations are not done at the right frequency, which is very high (around 15 days in the summer), which is technically very difficult to do in the context of mass production.

### SUMMARY OF THE DESCRIPTION

In this context, the invention aims to propose a sea rearing device that does not have the above drawbacks.

To that end, the invention relates to a device for rearing aquaculture animals at sea, comprising at least one stack of rearing enclosures superimposed on top of each other in a longitudinal direction, and blades linked to the rearing enclosures and arranged such that the rearing enclosures are rotated around a longitudinal axis by the sea current.

The blades linked to the rearing enclosures cause said enclosures to be rotated by the sea current.

The blades in particular allow the use of the driving tide force to rotate the rearing enclosures.

Indeed, the sea rearing facilities are primarily installed in relatively protected areas, such as sluices or rias or estuaries. There are therefore subject to the current from the tides channeled through the mouths. The force of the currents oscillates from 0 to a maximum between the high and low tides. The inversion periods where the current is zero occur at the high sea time and the low sea time. The strongest currents are midway in the period separating the high sea from the low sea. During the strong current period, typically during one third of the duration separating the high tide from the low tide, the stack forms an angle relative to the vertical. This incline allows the blades to face the current and thus rotate the rearing enclosures. Furthermore, the aquaculture animals will accumulate at the low points of the enclosures due to the incline. And thus, due to the rotation, the animals will be rolled against one another like balls in a concrete mixer, during the entire strong current period.

The rest of the time, the incline of the rearing enclosures is too small to cause a movement of the aquaculture animals, which allows the animals to eat and develop their growth.

The rearing device may also have one or more of the features below, considered individually or according to any possible technical combinations:

the device includes a marine turbine defining said blades;

the marine turbine is connected to the rearing enclosure located at a lower longitudinal end of the stack;

the marine turbine is connected to the rearing enclosure located at a lower longitudinal end of the stack by a binding or a rigid fastener;

the marine turbine is made from a plastic containing an additive provided to improve the solidity, or UV resistance, or resistance to soiling;

the blades are rigidly attached to the rearing enclosures and are longitudinally distributed along the stack;

the blades together form at least one propeller with a longitudinal axis;

the or each stack includes a plurality of plates superimposed longitudinally and slipped into a tubular net, the plates defining the rearing enclosures;

the rearing enclosures are rigid basket traps;

the or each stack includes a ballast;

the ballast is dimensioned so that the longitudinal direction forms, with the vertical, an angle comprised between 30° and 60° at the middle of a period separating the high tide and low tide;

the device includes a structure fixed to the seabed and a rotary connection of the or each stack to the structure, having a member authorizing a rotation of the or each stack relative to the structure around the longitudinal axis;

the or each stack is suspended from the structure by the rotary link, said rotary link being arranged to allow the or each stack to swing around a position where the longitudinal direction is vertical;

the structure includes a cable, or a raft, or a platform rigidly fixed to the seabed, the or each stack being connected to said cable or said raft or said platform;

the device comprises several stacks connected side by side to the structure, the respective blades of two adjacent stacks being arranged so that said two adjacent stacks are rotated relative to the structure along respective rotation directions opposite one another;

the or each rearing enclosure comprises at least one removable fastening zone for one of the blades;

the fastening zone is arranged to selectively allow the installation of the blade for the rotation in the direct direction or for the rotation in the indirect direction of the rearing enclosure.

### BRIEF DESCRIPTION OF THE DRAWINGS

Other features and advantages of the invention will emerge from the detailed description thereof provided below, for information and non-limitingly, in reference to the appended figures, in which:

FIG. 1 is a schematic illustration of a rearing device according to the state of the art;

FIG. 2 is a simplified schematic illustration of part of a rearing device according to the invention, according to a first embodiment;

FIG. 3 is a view similar to that of FIG. 2, showing the position of the stack of rearing enclosures in a period of strong current;

FIG. 4 is a perspective view of the marine turbine equipping the stack of FIGS. 2 and 3;

FIG. 5 is a simplified schematic illustration of a method for fastening the marine turbine to the lower plate of the device of FIGS. 2 and 3;

FIG. 6 is a side view of a rearing enclosure stack for a second embodiment of the invention;

FIG. 7 is an illustration of an alternative of the second embodiment of the invention;

FIGS. 8 and 9 are block diagrams illustrating the arrangement of the blades on the rearing enclosures of FIG. 6;

FIG. 10 illustrates an advantageous alternative of the rearing device according to the second embodiment of the invention;

FIG. 11 is a view along the incidence angle of arrow XI of FIG. 10;

FIGS. 12 and 13 schematically illustrate other types of structure fixed to the seabed and making it possible to suspend the enclosure stacks.

### DETAILED DESCRIPTION

The invention relates to a device for rearing aquaculture animals at sea. These animals are typically shellfish, and are more particularly oysters. Alternatively, the shellfish are all types of bivalves such as clams, mussels, or any other type of shellfish.

It is provided for rearing at sea, i.e., in deep water. This rearing can be done offshore from coasts or in sluices, estuaries or rias, or in ponds communicating with the sea, or in any other appropriate location.

It is particularly suitable for areas subject to the current from the tides.

The rearing device 1 includes a structure 29 fixed to the seabed.

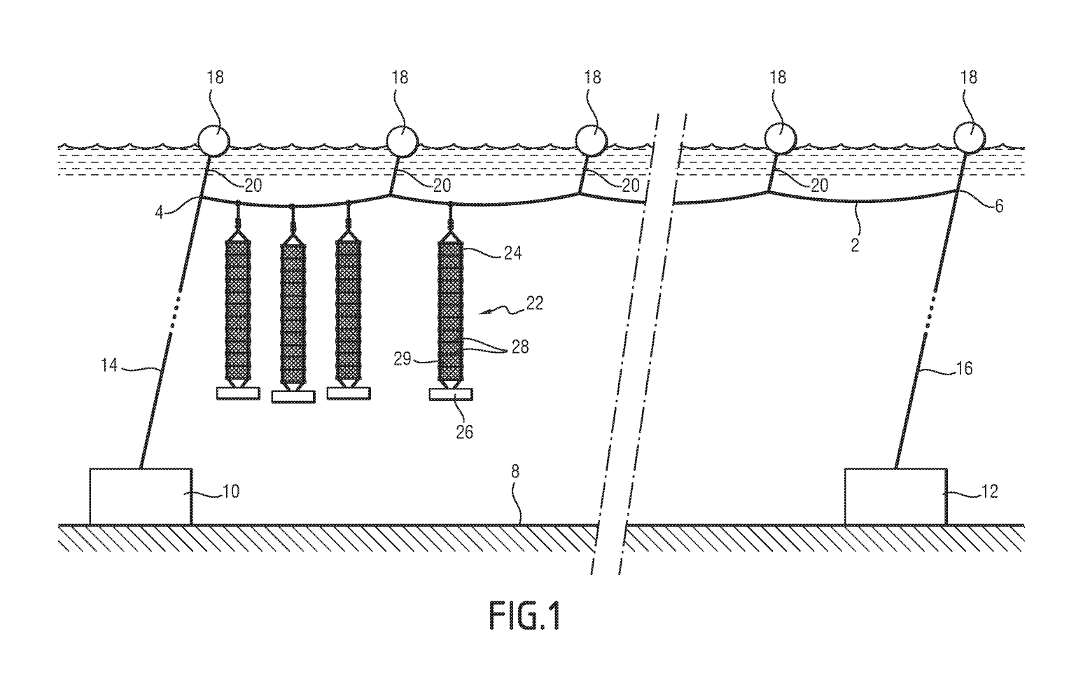

The structure 29 for example includes a cable 2 fixed to the seabed, for example as illustrated in FIG. 1 and described above.

Alternatively, the cable 2 is fixed to the seabed by any other appropriate system.

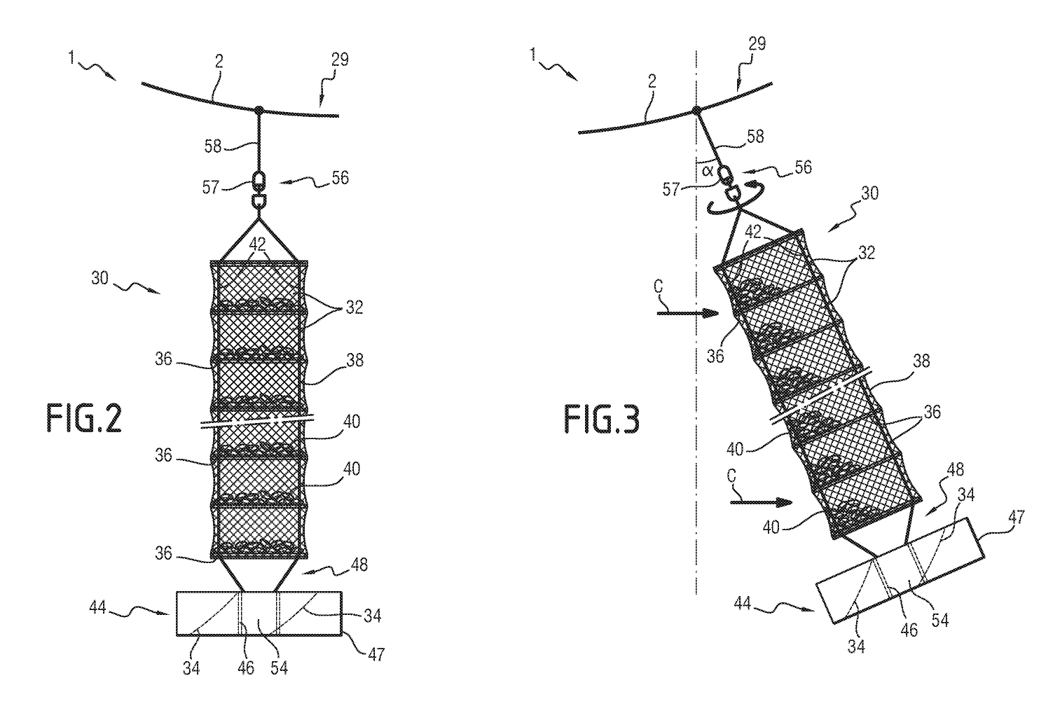

The device also includes at least one stack 30 of rearing enclosures 32, superimposed on top of each other in a longitudinal direction. In the illustration of FIG. 2, the longitudinal direction is vertical.

The device further includes blades 34 linked to the rearing enclosures 32 and arranged such that the rearing enclosures 32 are rotated around a longitudinal axis by the sea current.

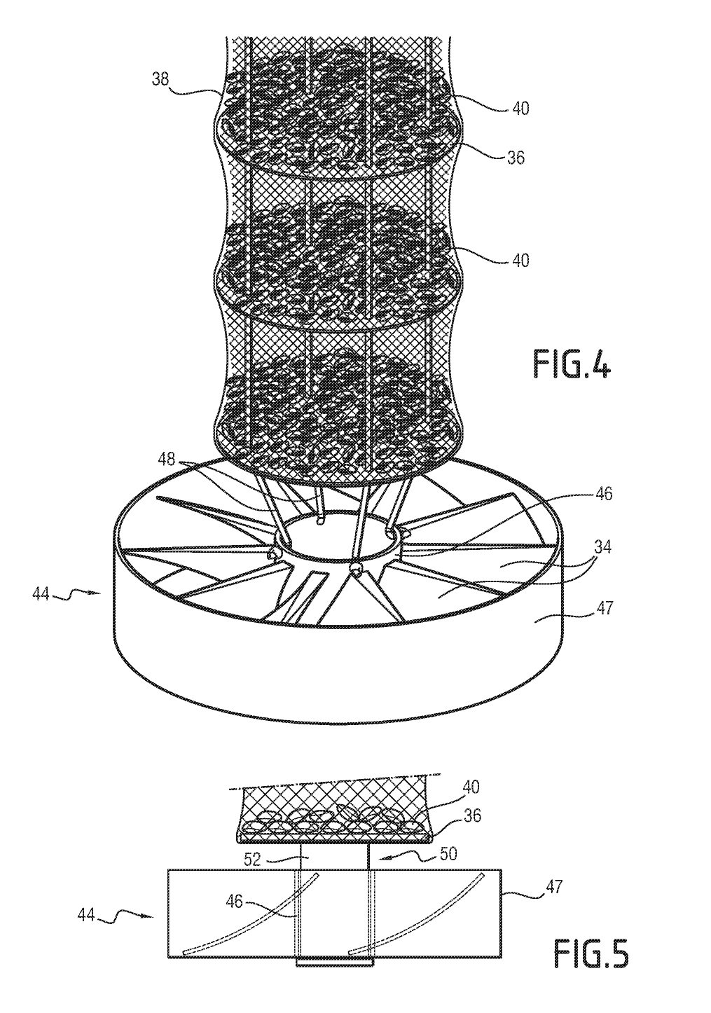

In the first embodiment, shown in FIGS. 2 to 5, the stack of rearing enclosures is a flexible Japanese lantern.

It thus includes a plurality of plates 36 superimposed longitudinally on top of each other. The plates 36 are slipped into a tubular net 38. The plates 36 define the rearing enclosures 32. The aquaculture animals 40 are arranged on the plates, in each rearing enclosure 32. The tubular net 38 is gripped by any means against the edge of each plate 36 so as to confine the animals 40 inside each enclosure. Typically, each plate 36 is fastened to longitudinally oriented ropes 42, provided to suspend the stack 30 from the cable 2.

According to the first embodiment, the device includes, for the or each stack 30, a marine turbine 44 defining the blades 34.

Here, a marine turbine refers to a hydraulic turbine, which uses the kinetic energy from the marine currents and converts it into a rotating movement of the rearing enclosures 32.

The marine turbine may be of any suitable type.

For example, as illustrated in FIGS. 2, 3 and 4, the marine turbine 44 includes a hub 46, a rim 47 surrounding the hub 46, the blades 34 each extending from the hub 46 to the rim 47. The number, shape and surface of the blades 34 are chosen so as to obtain a sufficient rotational driving force under the usage conditions that will be described later.

The marine turbine 44 is typically connected to the rearing enclosure located at a lower longitudinal end of the stack 30.

In other words, the marine turbine 44 is connected to the plate 36 located lowest in the stack.

In the example shown in FIGS. 2, 3 and 4, the marine turbine is connected to said rearing enclosure by a binding 48.

This means that cables connect the marine turbine 44 to the lower rearing enclosure 32.

Advantageously, the lower ends of the ropes 42 connect the marine turbine 44 to the lower rearing enclosure 32.

The binding 48 connects the hub 46 to the lower rearing enclosure.

In an alternative embodiment shown in FIG. 5, the marine turbine 44 is connected to the lower rearing enclosure 32 by a rigid fastener 50. This rigid fastener is for example a clip.

For example, the plate 36 includes an extension 52 attached below said plate, clipping inside the hub 46 of the marine turbine.

The marine turbine 44 is placed below the stack 30, along the longitudinal direction. In other words, it is placed longitudinally below the lower rearing enclosure 32.

The marine turbine 44 is typically made from an injected plastic material, for example polypropylene. It may also include blades made from flexible materials, for example canvas, such as canvas for sails or parachutes. These materials advantageously contain an additive to improve solidity, UV resistance, or soiling resistance (anti-fooling effect).

Preferably, the or each stack 30 includes a ballast 54. The ballast 54 is for example mounted in the hub 46 of the marine turbine. For example, the ballast 54 is a ring made from steel or lead, or a concrete block.

The device also includes a rotary link 56 connecting the stack 30 to the structure 29, here to the cable 2. The rotary link 56 includes a rotary member 57 that allows the stack 30 to rotate relative to the structure 29 around the longitudinal axis.

The rotary link is of any suitable type. For example, the member 57 is a swivel or any other equivalent member allowing the rotation of the stack 30.

The link 56 is designed so that the stack 30 is suspended from the structure 29, and can swing around a position where the longitudinal axis is vertical, as shown in FIGS. 2 and 3.

In the example shown in FIG. 2, the link 56 comprises a cable 58 which in turn is fixed to the cable 2. The rotary member 57 attaches the cable 58 to the stack 30, preferably to the upper ends of the ropes 42.

As indicated above, the rearing device 1 is provided to be installed in a zone subject to the current from the tides. In the inversion periods, i.e., the high sea time and the low sea time, the tide currents are weak. The rearing enclosure stack 30 therefore adopts a position where the longitudinal direction is substantially vertical, as illustrated in FIG. 2. The axis of the hub 46, i.e., the axis of the marine turbine 44, is substantially vertical. In this position, the marine turbine is not rotated. The rearing enclosures are therefore substantially static. These conditions are favorable for the aquaculture animals 40 to be able to eat and develop.

On the contrary, during the entire strong tide current period, the stack 30 is tilted, as illustrated in FIG. 3. In other words, the longitudinal direction forms an angle α with the vertical. This angle α depends on the strength of the tide currents and the weight of the ballast 54. The tide currents are shown by the arrows C in FIG. 3.

The ballast 54 is dimensioned so that the longitudinal direction forms, with the vertical, an angle α of between 30° and 60° at the middle of a period separating the high tide and low tide.

In other words, the angle α at the moment where the tide currents are the strongest is between 30° and 60°.

This angle depends on the strength of the current and therefore the strength of the tide and therefore the tide coefficient, which varies each day between the spring tide (high tide) and neap tide (low tide) periods. The weight of the ballast 54 is chosen so that the angle α stays in the range indicated above, which allows the rotation during a sufficient number of days between two neap tide periods to obtain the expected hardening results based on the nature of the rearing (enlargement, finishing stage, etc.).

It should be noted that the presence of the ballast is not mandatory. In some cases, the weight of the marine turbine 44 and/or the assembly 30 of rearing enclosures 32 or animals 40 are sufficient to obtain the desired effect. The blades 34 are arranged such that, for a substantially horizontal sea current, and for an angle α of between 30° and 60°, the rearing enclosures 32 are rotated around the longitudinal axis by the sea current C.

The surface and the incline angle of the blades 34 are in particular adjusted relative to the sea current C.

In the illustrated example, the rearing enclosures 32 are connected to each other in rotation around the longitudinal axis. They are typically connected by the ropes 42.

The marine turbine 44 rotates the lower rearing enclosure 32 around the longitudinal axis. The latter rotates the enclosure located immediately above it, and so forth, up to the enclosure 32 located on top of the stack 30. The rotary link 56 allows the rotational movement of the top rearing enclosure 32 relative to the structure 29.

As shown in FIG. 3, the rearing enclosures 32 are tilted relative to the horizontal. In the illustrated example, the plates 36 form an angle α relative to the horizontal.

The aquaculture animals therefore gather at a low point of each rearing enclosure 32. Due to the rotation of the rearing enclosures, the reared animals continuously tumble toward the low point of the rotating plates and roll against each other.

Typically, the blades 34 are arranged so that, in light of the force of the sea currents in the zone where the rearing device is installed, such a rotational movement occurs at least for 25 to 50% of the time separating the high tide and the low tide, ideally during one third of said duration.

During the rest of the time, the incline, i.e., the angle α, is too small to cause a movement of the aquaculture animals.

Such a movement promotes self-cleaning of the rearing enclosures 32. It also promotes abrasion of the shells of the aquaculture animals making it possible to avoid overgrowth and sticking by nacration of the animals to one another or on the rearing enclosures.

This also promotes the finishing stage of the animals, since the dietary effort is not exclusively diverted toward growth of the shell, but is also dedicated to reserve accumulation.

Typically, the sea rearing device 1 includes a plurality of stacks 30, each connected to the structure 29 by a rotary link 56. Each stack is identical to that described above, and is equipped with its own marine turbine 44. When the structure 29 includes a cable 2, the stacks 30 are fixed side by side, regularly spaced apart along the cable 2, as illustrated in FIG. 1.

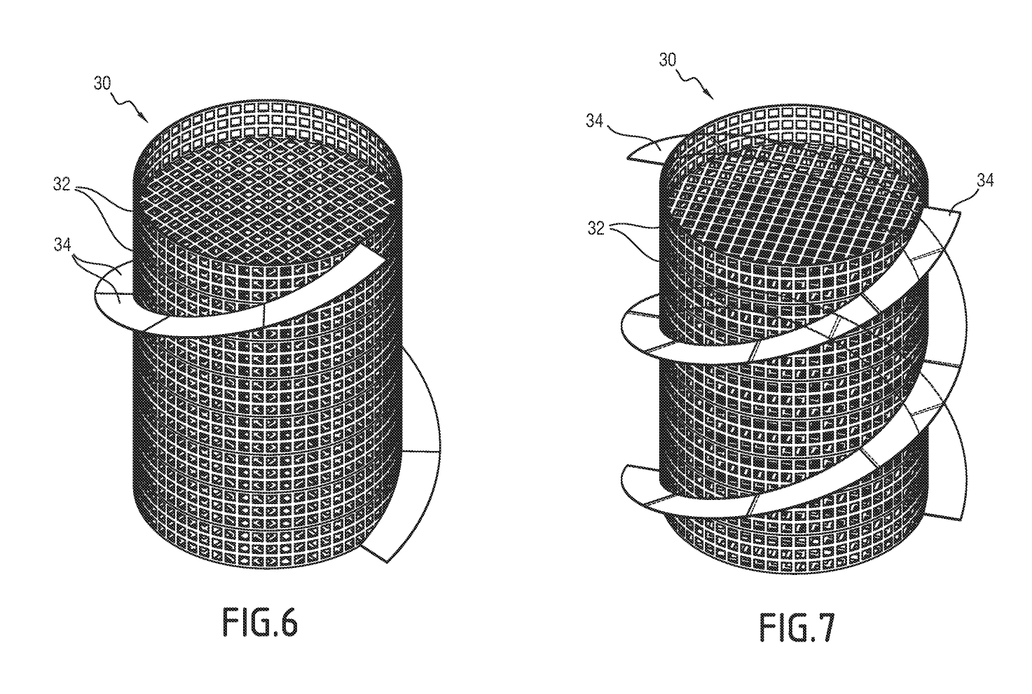

A second embodiment of the invention will now be described in reference to FIGS. 6 to 11.

Only the differences between the second embodiment and the first will be outlined below. Identical elements or elements performing the same function will be designated using the same references.

In the second embodiment, the rearing enclosures are rigid basket traps. The stack 30 does not constitute a flexible Japanese lantern, but a rigid Japanese lantern. Each basket trap includes one or several walls made up of a mesh, the aquaculture animals being arranged inside the basket. The baskets 32 are rigidly fixed to one another.

This arrangement is illustrated in FIG. 9, which shows a side view of the basket traps 32.

In the second embodiment, the blades 34 are rigidly attached to the rearing enclosures 32 and are longitudinally distributed along the stack 30.

More specifically, the blades 34 advantageously form at least one propeller with a longitudinal axis. The propeller winds around the stack 30 as illustrated in FIG. 6.

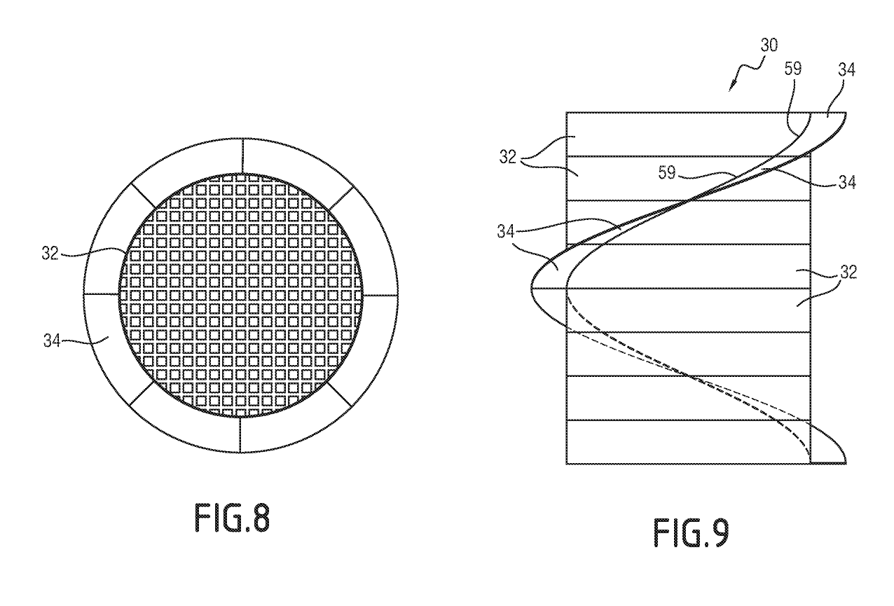

Typically, a given rearing enclosure 32 bears at least one of the blades 34. As illustrated in FIGS. 8 and 9, the blades carried by the enclosure immediately above and the enclosure immediately below in the stack 30 can be placed in the extension of one another.

For example, each blade 34 extends over one eighth of a revolution, such that the blades carried by eight consecutive enclosures in the stack make it possible to form a continuous propeller revolution with a given pitch.

Preferably, it takes between four and ten enclosures to produce one pitch, or one revolution of the propeller.

Advantageously, the blades 34 form a simple propeller. Such a propeller is illustrated in FIG. 6. In this case, each enclosure bears a single blade 34.

In an alternative embodiment illustrated in FIG. 7, the blades 34 form a double propeller. A double propeller includes two helical nets, parallel to one another. In this case, each enclosure 32 bears two blades 34, which are typically diametrically opposite.

In the second embodiment of the invention, each rearing enclosure 32 typically has a circular section perpendicular to the longitudinal direction.

In the second embodiment, each stack 30 includes a ballast 54 as described relative to the first embodiment of the invention.

In the second embodiment, the sea current drives the stack 30 by acting on the helical propeller.

It should be noted that the propeller does not necessarily extend over the entire height of the stack. Thus, some rearing enclosures 30 may not be equipped with blades 34. The propeller may be discontinuous and include two segments separated by a space not equipped with blades.

Typically, the blades 34 may be removable, which makes it possible to adapt the number and the size of the blades 34 to the circumstances or the desired effects.

Each rearing enclosure 30 thus includes at least one zone 59 arranged for the removable fastening of one of the blades 34. The zone 59 is for example arranged to clip the blade 34. Alternatively, the zone 59 allows fastening by screwing or any other means.

There are for example multiple fastening zones 59 waiting on the basket traps, thus making it possible to form one or several propellers.

The fastening zones 59 advantageously make it possible to install the removable blades in the direct or indirect rotation directions, thus making it possible, with the same basket trap, to form lanterns with direct or indirect helical rotation.

The length and width of the propeller are chosen based on the desired driving force.

As described above, the device 1 typically comprises several stacks 30 connected side by side to the structure 29. The space separating the stacks 30 along the structure 29 is generally smaller than the height of each stack 30. During stronger tides, each stack risks coming into contact with the adjacent stacks.

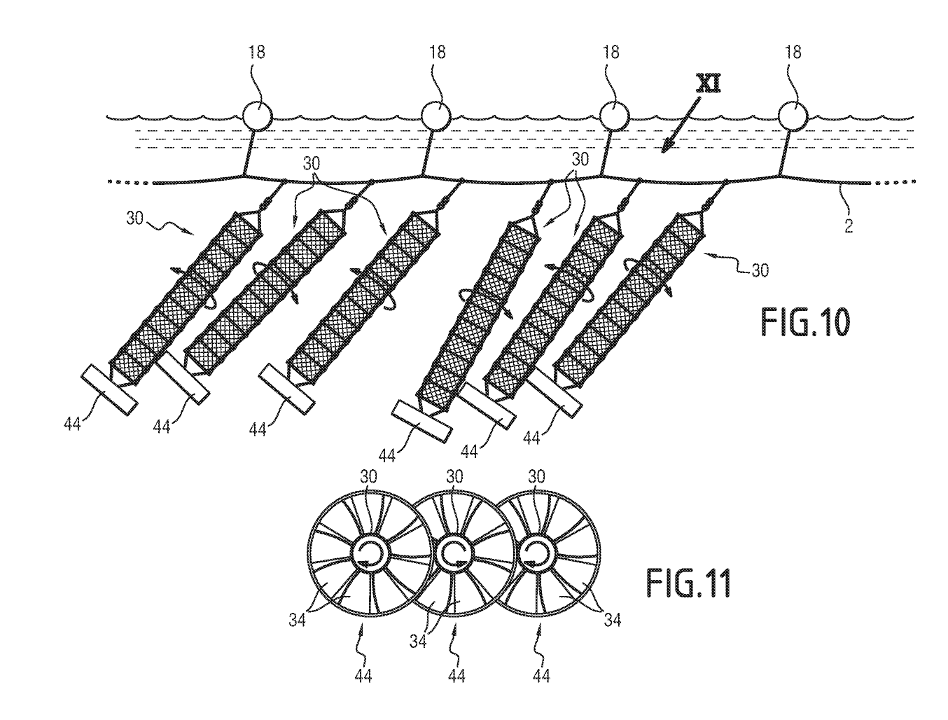

To avoid friction between the stacks, the respective blades of two adjacent stacks 30 are arranged so that said two adjacent stacks 30 are rotated relative to the structure 2 along respective rotation directions opposite one another. This is illustrated in FIGS. 10 and 11. Thus, in case of contact during very strong tides for example, the stacks 30 roll against one another, like a gear.

Alternatively, the stack 30 of rearing enclosures made up of rigid basket traps may not be equipped with blades forming a helical propeller, but may be equipped with a marine turbine of the type described relative to the first embodiment of the invention.

Conversely, the stack 30 of the flexible Japanese lantern type may not be equipped with a marine turbine, but rather with blades secured to each rearing enclosure and together defining a propeller with a longitudinal axis like the second embodiment of the invention. In this case, the blades 34 are advantageously rigidly fixed to the plate 36, and the plates 36 are fixed in rotation relative to each other.

The structure 29 may not comprise a cable 2 of the type described above.

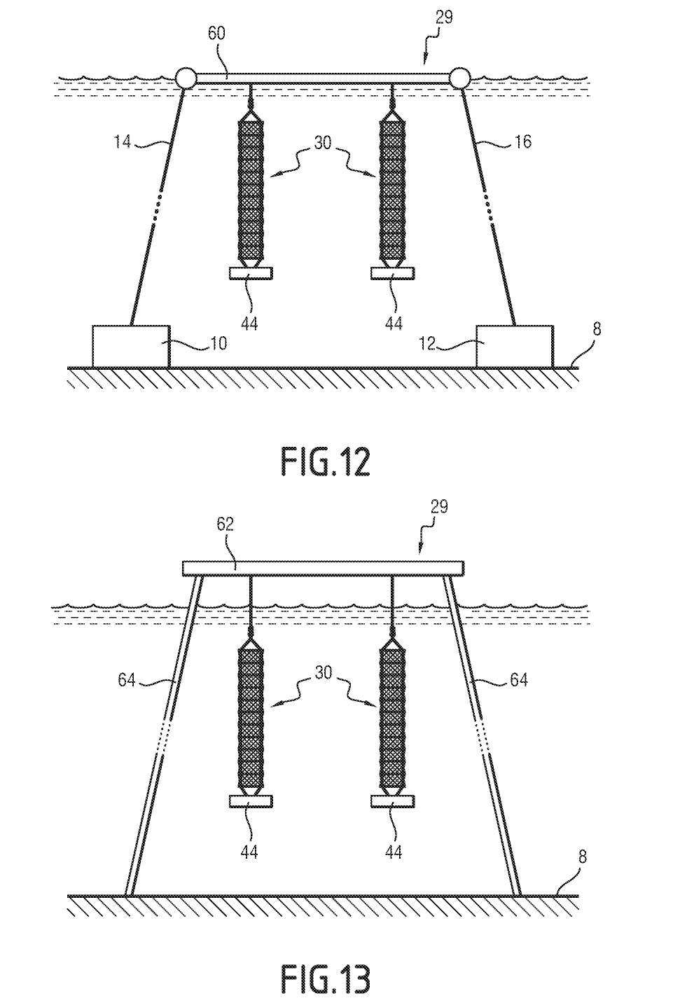

Alternatively, the structure 29 fixed to the seabed comprises a raft 60 of the type illustrated in FIG. 12. The raft floats on the surface of the water and is fixed to the seabed 8 for example using ballasts 10, 12 and cables 14, 16. One or several stacks 30 are suspended from the raft 60.

According to another alternative, the structure 29 includes a platform 62 rigidly fixed to the seabed 8. The platform 62 is fixed by rigid posts 64. One or several stacks 30 are suspended from the platform 62.

The present invention eliminates the overgrowth phenomena while allowing homogeneous growth of the shellfish. Due to the abrasion related to the movement, it makes it possible to obtain shellfish with a perfect shape and a hard shell. The self-cleaning phenomenon, as well as the slowing of the growth, greatly limit the action of pathogenic agents and the consequences of cadaveric degradations after mortalities. On animals of consumable size, it further promotes a high finishing stage rate making it possible to obtain, in addition to a very good shape and shell quality, a flesh level classifying these products in the top tier category (highest flesh indices of the market).

1. A device for rearing aquaculture animals at sea, comprising:
at least one stack of rearing enclosures, superimposed on top of each other in a longitudinal direction;
blades linked to said rearing enclosures and arranged such that said rearing enclosures are rotated around a longitudinal axis by the sea current;
a structure fixed to the seabed; and
a rotary connection of said or each said stack to said structure, comprising a member authorizing a rotation of said or each said stack relative to said structure around the longitudinal axis,
wherein said or each said stack is suspended from said structure by said rotary connection, said rotary connection being arranged to allow said or each said stack to swing around a position where the longitudinal direction is vertical.

2. The device according to claim 1, further comprising a marine turbine defining said blades.

3. The device according to claim 2, wherein said marine turbine is connected to said rearing enclosure located at a lower longitudinal end of said stack.

4. The device according to claim 3, wherein said marine turbine is connected to said rearing enclosure located at a lower longitudinal end of said stack by a binding or a rigid fastener.

5. The device according to claim 2, wherein said marine turbine is comprised of a plastic containing an additive provided to improve the solidity, or UV resistance, or resistance to soiling.

6. The device according to claim 1, wherein said blades are rigidly attached to said rearing enclosures and are longitudinally distributed along said stack.

7. The device according to claim 6, wherein said blades together form at least one propeller with a longitudinal axis.

8. The device according to claim 1, wherein said or each said stack includes a plurality of plates superimposed longitudinally and slipped into a tubular net, the plates defining said rearing enclosures.

9. The device according to claim 1, wherein said rearing enclosures are rigid basket traps.

10. The device according to claim 1, wherein said or each said stack comprises a ballast.

11. The device according to claim 10, wherein said ballast is dimensioned so that the longitudinal direction forms, with the vertical, an angle between 30° and 60° at the middle of a period separating the high tide and low tide.

12. The device according to claim 1, wherein said structure comprises a cable, or a raft, or a platform rigidly fixed to the seabed, said or each said stack being connected to said cable or said (60) or said platform.

13. The device according to claim 1, further comprising several stacks connected side by side to said structure, the respective blades of two adjacent stacks being arranged so that the two adjacent stacks are rotated relative to said structure along respective rotation directions opposite one another.

14. The device according to claim 1, wherein said or each said rearing enclosure comprises at least one removable fastening zone for one of said blades.

15. The device according to claim 14, wherein said fastening zone is arranged to selectively allow the installation of said blade for rotation in the direct direction or for rotation in the indirect direction of said rearing enclosure.
